(19) United States
(12) Patent Application Publication
(10) Pub. No.: US 2011/0231044 A1
(43) Pub. Date: Sep. 22, 2011

(54) POWER SUPPLY SYSTEM FOR ELECTRIC VEHICLES AND METHOD FOR CONTROLLING SAME

(76) Inventor: Jochen Fassnacht, Calw (DE)

(21) Appl. No.: 13/122,431

(22) PCT Filed: Sep. 25, 2009
(86) PCT No.: PCT/EP09/62446

§ 371 Date: Jun. 6, 2011

(30) Foreign Application Priority Data
Oct. 8, 2008 (DE) 10 2008 042 677.6

(51) Int. Cl. B60L 15/00; H02J 7/00

(52) U.S. Cl. 701/22; 320/109

(57) ABSTRACT

A power supply system for electric vehicles is described having an on-board energy storage and an on-board charging device, which is connectable to a grid connection station of a stationary power supply grid in order to charge the on-board energy storage. An interface is provided between an on-board component and a stationary component for connecting the charging unit to the grid connection station of the power supply grid during the charging operation in order to transmit operating characteristics of the power supply grid to the on-board charging device. Furthermore, a method for controlling the power supply system is also described.

### FIELD OF THE INVENTION

The present invention relates to a power supply system for electric vehicles, and a method for controlling a power supply system.

### BACKGROUND INFORMATION

Electric vehicles in the sense of the present invention are understood to be vehicles equipped only with an electric drive. In addition, this term should also be understood to include so-called plug-in hybrids. Plug-in hybrids are hybrid vehicles having a larger storage for electric power which is rechargeable from the electric power grid. Vehicles of this type thus require a power connector for the connection to the electric power grid during the charging operation. The goal is to minimize the time required for the charging operation because users of such vehicles will base their expectations of convenience on the comparatively short refueling pauses for refueling a vehicle with gasoline or diesel. The charging time may be minimized if the maximum possible power is drawn from the power grid. From today's standpoint, the limiting factor is usually the maximum power drawable from the grid, in particular in the private sector. Power receptacles available for charging an energy storage today are usually protected with a fuse, which must then be reset manually after being triggered when the allowed current is exceeded. To overcome this disadvantage, the maximum allowed charging current drawable from the grid must thus be known to the vehicle when an energy storage to be charged is connected. In this way, is it possible for the charging operation to proceed rapidly and smoothly. This is particularly important if the vehicle is to be charged not only at the home receptacle but also at any receptacles, for example, at the job site, in a parking garage, at a service station, or the like. The charging operation in foreign countries must also be considered particularly critically because different grid voltages, different grid frequencies, a different maximum current and different grid configurations must be expected there. Although the parameters of grid voltage and grid frequency may be detected comparatively easily by the on-board charging circuit, however, this is not readily true of the maximum charging current drawable from the grid via the power receptacle being used. The charging current could be limited in general to a comparatively low value, which could also be made available at any available power receptacle for charging at practically any time even under the least favorable conditions. However, this would result in a comparatively long charging operation. Another alternative would be to install signs indicating the allowed operating parameters on the receptacles and manual input of these operating parameters into the charging circuit at the start of a charging operation. However, this is not convenient and does not rule out operating errors, which could result in a disturbance in the charging operation.

U.S. Published Patent Application No. 2006/0250902 A1 also describes a plug-in hybrid vehicle which is connectable to a power supply grid in such a way that a bidirectional power flow is possible.

### SUMMARY

An object of the present invention is to provide a power supply system for electric vehicles, which enables the fastest and most reliable possible charging operation of an electric vehicle on a public power grid.

In accordance with the present invention, the charging operation may be optimized in the desired sense through automatic transmission of the allowed operating parameters from the grid to the vehicle on initiation of the charging operation, which is thus largely free of operating errors.

An advantage of the present invention offers is that the driver of an electric vehicle will perceive the charging operation of the on-board energy storage to be as convenient as a traditional stop at a filling station to refuel a vehicle with gasoline or diesel. The aforementioned operating parameters are transmitted in a particularly advantageous manner through suitable coding of a plug connection which is established between a mobile plug and a stationary receptacle in a grid connection station, for example. The receptacle may advantageously have mechanical coding elements, color coding, barcodes or the like as well as any combination of these coding elements which are then detected by a suitably designed plug on the electric vehicle. If a navigation system is present in the vehicle, the location of a grid connection station and the operating parameters prevailing there may also be displayed on the display screen of the navigation system in a particularly advantageous manner. In another advantageous specific embodiment of the present invention, the operating parameters are also transmitted by a transponder system or by a mobile telephone in a wireless, i.e., noncontact, transmission. In the case of a parking facility equipped with multiple parking spaces and grid connection stations such as parking lots, parking garages or the like, the location of available parking spaces having grid connection stations and the particular allowed operating parameters for the charging operation may be displayed already in the entrance area in an advantageous manner. It is also possible to have targeted guidance of an entering vehicle to an optimally suited available parking space having a grid connection station.

Additional advantages of the present invention may be derived from the following description, and the figures.

### BRIEF DESCRIPTION OF THE DRAWINGS

The present invention is explained in greater detail below based on the figures as an example.

FIG. 1 shows a schematic representation of a power supply system for an electric vehicle.

FIG. 2 shows the receptacle of a grid connection station.

FIG. 3 shows the display screen of a navigation system having a display of a grid connection station.

FIG. 4 shows the coded voltage characteristic of a grid connection station.

FIG. 5 shows a plug connection having a transponder system.

FIG. 6 shows a parking garage having grid connection stations and a display device.

### DETAILED DESCRIPTION OF EXAMPLE EMBODIMENTS

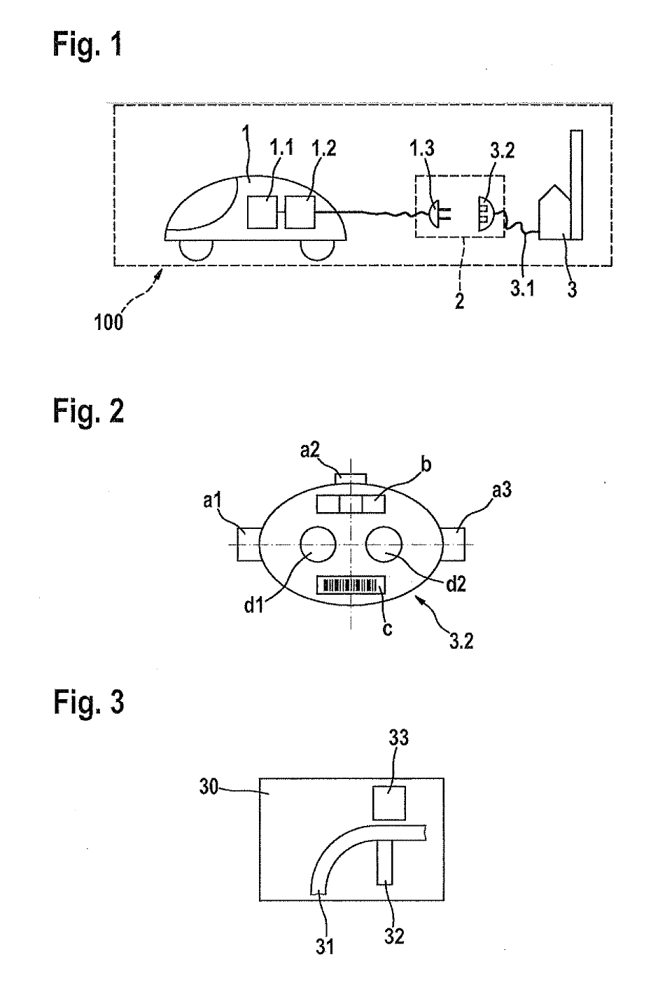

FIG. 1 shows a schematic representation of a power supply system 100 for an electric vehicle 1. Electric vehicle 1 here is representative of a variety of electric vehicles using power supply system 100 according to the present invention. Power supply system 100 includes components utilized jointly by all electric vehicles 1, in particular stationary components and on-board components, i.e., mobile components. The jointly used components include at least one power source, in particular stationary, for dispensing power, for example, a power plant 3 and a power supply grid 3.1 connected to the power source. The power plant may be any traditional power plant generating electric power from fossil energy sources, such as coal or gas, or by hydrodynamic power. Use of modern solar systems or wind power systems is also possible. Power supply system 100 also includes at least one grid connection station 2. A plug connection between a stationary receptacle 3.2 and an on-board plug 1.3 in the grid connection station 2 allows power transmission between stationary power supply grid 3.1 and a mobile consumer. Power supply system 100 also includes at least one electric vehicle 1 having at least one on-board energy storage 1.1, in particular at least one chargeable battery, and having at least one charging device 1.2. Power is supplied to electric vehicle 1 from stationary power supply grid 3.1 by establishing an electrically conducting connection or an inductive connection via a plug connection 1.3, 3.2 in a grid connection station 2. Based on the problems described above, the most accurate possible knowledge of the operating parameters of the stationary power supply grid is used for the charging operation in order to avoid overloading the power supply grid and to enable the fastest possible charging of the on-board energy storage. According to the present invention, the allowed operating parameters of power supply grid 3.1 which is available for charging on-board energy storage 1.1 is automatically transmitted. According to the present invention, this is possible via several exemplary embodiments, which are described in greater detail below.

FIG. 2 shows a top view of the contact side of a receptacle 3.2, which is in a stationary position in a grid connection station 2. The poles of receptacle 3.2, which are intended for receiving pins 3 of plug 1.3, are labeled as d1, d2. According to a first embodiment variant of the present invention, the allowed operating parameters may be transmitted when plug connection 1.3, 3.2 is established in grid connection station 2, by detecting a mechanical structural coding of stationary receptacle 3.2 by mobile plug 1.3. The aforementioned coding may be embodied, for example, in the form of radially protruding lugs a1, a2, a3 (FIG. 2), which are sensed by form-fitting recesses in plug 1.3. Various other embodiments of the coding elements, for example in the form of grooves, notches, boreholes or the like, which are scanned by form-fitting complementary structures on the side of plug 1.3, are also possible. In another embodiment variant, a color code b may be provided on receptacle 3.2 and read by a corresponding sensor in plug 1.3. In another embodiment variant, a barcode identifying the operating parameters may be provided on the receptacle and detected by a sensor provided in plug 1.3. In addition, any combinations of the coding described above are also possible. Furthermore, plug connections having an inductive coupling for the purpose of power transmission and/or data transmission are also possible.

In an electric vehicle 1 equipped with a navigation system, the location of a grid connection station and the operating parameters to be taken into account there may also be displayed on the display screen of the navigation system in a particularly advantageous manner. This is illustrated with reference to FIG. 3, which shows schematically a display screen 30 of a navigation system. According to the display on the screen, a grid connection station labeled with reference numeral 33 is situated in the immediate vicinity of a junction of two roads 31, 32. The power supply system may also be designed advantageously in such a way that the particular charge state of energy storage 1.1 is detected, emphasizing in particular any grid connection stations which are still reachable, depending on the charge state.

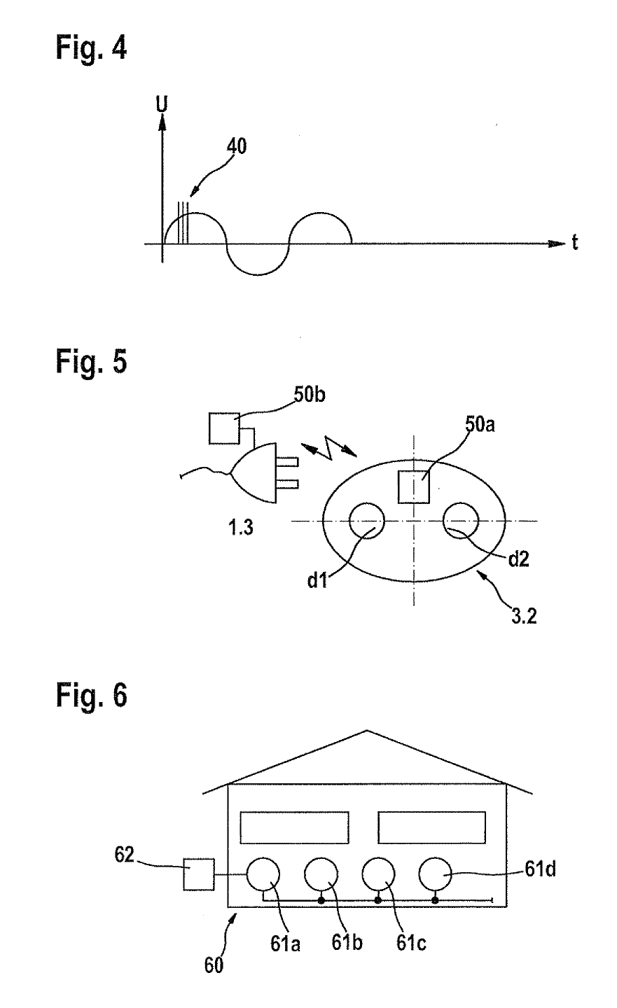

In another example embodiment variant of the present invention, the operating parameters may also be transmitted by a coding superimposed on the voltage curve of charging voltage U supplied in the grid connection station. This is illustrated in FIG. 4, which shows a diagram of the voltage characteristic (voltage U) as a function of time t. Coding 40 in the form of voltage pulses superimposed on voltage U is readable by charging device 1.2.

Additional embodiment variants are explained below with reference to FIG. 5. A wireless transponder system or a radio telephone system may advantageously be provided with transmission device 50a in receptacle 3.2 and a reception device 50b in plug 1.3. The transponder system may advantageously operate by inductive coupling, by high-frequency signal transmission or may be designed as an infrared interface.

With the growing popularity of electric vehicles, parking facilities such as parking lots, parking garages or the like will in the future be equipped with grid connection stations for electric vehicles. FIG. 6 shows a parking garage 60 equipped with grid connection stations 61a, 61b, 61c, 61d allocated to individual parking spaces. To allow the most convenient possible power supply to electric vehicles being parked, a display device may advantageously be located in the entrance area of parking garage 60, the available parking spaces having grid connection stations and the corresponding operating parameters being shown on such a display device. A targeted guidance of an entering electric vehicle to an optimally suitable parking space is also possible in that the operating parameters of the available grid connection stations are already being compared with the vehicle parameters by data transmission when the electric vehicle enters the facility.

The power supply system for an electric vehicle designed according to the present invention may be controlled in the following way according to the present invention. At the latest when a plug connection is established between an on-board plug 1.3 and a stationary receptacle 3.2 in a grid connection station 2, allowed operating parameters of stationary power supply grid 3.1 are transmitted to on-board charging device 1.2. Charging device 1.2 then controls the charging operation of on-board energy storage 1.1 in such a way that the charging operation proceeds as rapidly as possible without causing an inadmissible overload on stationary power supply grid 3.1.

In one embodiment variant of the present invention, interface 1.3, 3.2, 50a, 50b between the mobile and stationary components of power supply system 100 is designed advantageously in particular to be bidirectional for data exchange. While on the one hand the operating parameters of the stationary power supply grid may be transmitted to vehicle 1, the charge state of on-board energy storage 1.1 may be reported back in the opposite direction. The grid connection station currently being used by the vehicle may then be deactivated until the departure of the vehicle in order to allocate the remaining resources of the power supply grid to other grid connection stations.

1-13. (canceled)

14. A power supply system for an electric vehicle, comprising:
at least one on-board energy storage;
at least one on-board charging device which is connectable to a grid connection station of a power supply grid for charging the at least one on-board energy storage; and
an interface between an on-board component and a stationary component to connect the charging device to the grid connection station of the power supply grid during the charging operation to transmit operating characteristics of the power supply grid to the on-board charging device.

15. The power supply system as recited in claim 14, wherein the interface includes a plug connection.

16. The power supply system as recited in claim 14, wherein the interface is bidirectional for data exchange.

17. The power supply system as recited in claim 15, wherein the plug connection has a structural coding.

18. The power supply system as recited in claim 17, wherein the structural coding includes lugs.

19. The power supply system as recited in claim 15, wherein the plug connection includes at least one of a color coding and a coding pattern.

20. The power supply system as recited in claim 15, wherein the plug connectors includes a barcode.

21. The power supply system as recited in claim 14, wherein a position of the grid connection station and the operating characteristics of the power supply grid are stored in a navigation system and are retrievable by the electric vehicle.

22. The power supply system as recited in claim 14, wherein the operating characteristics of the power supply grid are imposed on a voltage signal supplied at the grid connection station and are retrievable there by the on-board charging device.

23. The power supply system as recited in claim 15, wherein the plug connection includes a transceiver device/transponder via which the operating characteristics of the power supply grid are wirelessly transmissible to the on-board charging device.

24. The power supply system as recited in claim 15, wherein the plug connection includes an infrared interface for transmitting the operating characteristics of the power supply grid to the on-board charging device.

25. The power supply system as recited in claim 14, wherein the operating characteristics of one of the power supply grid or the grid connection station connected thereto are retrievable via at least one of the Internet or a wireless.

26. The power supply system as recited in claim 14, wherein the on-board charging device receives a local position of an available grid connection station and the operating characteristics of the power supply grid to be encountered there at an entrance to the parking facility.

27. A method for controlling a power supply system for an electric vehicle having at least one energy storage and at least one charging device in which the energy storage is chargeable on a power supply grid, comprising:
receiving a report of maximum current drawable from the power supply grid before a start of a charging operation by the charging device of the electric vehicle; and;
controlling, by the charging device, a charging current in such a way that the current does not exceed a maximum reported value.

28. The method as recited in claim 27, further comprising:
reporting a charge state of the on-board energy storage to the power supply grid.
